(19) United States
(12) Patent Application Publication
(10) Pub. No.: US 2004/0120521 A1
(43) Pub. Date: Jun. 24, 2004

(54) Method and system for data encryption and decryption

(76) Inventors: Kevin M. Henson, Garland, TX (US); Eric M. Smith, Dallas, TX (US)

Correspondence Address: Robert C. Klinger, Jackson Walker LLP., Suite 600, 2435 North Central Expressway, Richardson, TX, 75080, US

(21) Appl. No.: 10/683,945

(22) Filed: Oct. 10, 2003

Related U.S. Application Data
(60) Provisional application No. 60/417,608, filed on Oct. 10, 2002.

(51) Int. Cl. H04L 9/00

(52) U.S. Cl. 380/45

(57) ABSTRACT

A method and system for data encryption and decryption utilizing relative vector offsets, concealed within poly-alphabetic substitutions, and a multi-distance cipher chaining scheme. The encryption and decryption algorithm includes integer based offsets, XOR's, and Variable-Exchange-Tables (VETs). Crypto-Variables necessary to accomplish the encryption and decryption are randomly selected and placed in an Initialization-vector which is encrypted with a block cipher. The present invention achieves superior encryption security and processing speed, and generates a different encryption for a same character. The use of the VETs alone achieves a key in excess of 40,000 bits, and the process of XOR'ing characters with a trailing cipher chain produces an extremely large key.

### CLAIM OF PRIORITY

This application claims priority of U.S. Patent Application Serial No. 60/417,608 filed Oct. 10, 2002 entitled “Method and System for Data Encryption and Decryption”, the teachings of which are incorporated herein by reference.

### TECHNICAL FIELD OF THE INVENTION

This invention relates generally to the field of information handling, and more specifically to a method and system for data encryption and decryption.

### BACKGROUND OF THE INVENTION

The security of information poses challenges for businesses and other organizations that transmit and store sensitive information. Data encryption is intended to transform data into a form readable only by authorized users. One encryption method encrypts data in fix-sized blocks known as block ciphers. A typical block cipher will input 128 bits and output 128 bits of cipher text. This cipher will apply a secret key to the plain text in order to achieve the encryption. It is often written E(K,p).

Collision attacks such as birthday and meet-in-the-middle attacks have been proven to reduce an exhaustive key search significantly against block ciphers. Also, new attacks known as XSL (Equation Solving Attacks) have also shown positive results. Research is also being done in the field of Quantum computing. Advances in this field will make it possible to reduce the time it takes to perform an exhaustive key search significantly. Therefore, a need has arisen to invent an encryption algorithm that can repel the aforementioned attacks and yet still be fast enough to handle data intensive applications that are common in the computer environment.

The first half of the twentieth century saw the rise of mechanical encryption devices that used rotors with electrical contacts to rapidly perform substitutions operations. The security of these systems lay in the large number of possible initial settings. There are inherent weaknesses in rotor-based encryption when the individual rotors increment by a fixed amount, typically 1, as in the fashion of an odometer. Relationships between the outputted characters will reveal themselves eventually given enough time and data. William F. Friedman's solution to the problem was to increment the rotors in a more erratic fashion.

While known approaches have provided improvements over prior approaches, the challenges to encrypt digital data continue to increase with demands for more and better techniques having greater effectiveness. Therefore, a need has arisen for a new method and system for data encryption.

### SUMMARY OF THE INVENTION

The present invention achieves technical advantages as a method and system for data encryption that substantially eliminates the disadvantages and problems associated with previously developed systems and methods.

This system and method according to the present invention is a multi-staged encryption system utilizing relative vector offsets, concealed within poly-alphabetic substitutions, and a multi-distance cipher chaining scheme. The present invention includes integer based offsets, XORs, and Variable-Exchange-Tables (VETs) to achieve superior encryption security and processing speed.

According to one embodiment of the present invention, a system and method for data encryption is disclosed. Plain characters are received, and a Key-Table that includes key characters corresponding to the plain characters is accessed. Crypto-Variables necessary to accomplish the encryption are randomly selected and placed into an Initialization-Vector (IV). The IV is encrypted with a block cipher (AES) in order to obscure the Crypto-Variable settings. A trailing cipher character is selected from the encrypted IV and subjected to substitutions from trailing Variable-Exchange-Tables (VETs). The selection and settings for these VETs are defined in the IV.

The following is repeated for each plain character to encrypt the plain characters. The first step is XOR'ing the plain text with the above mentioned trailing cipher character. Next, a vector offset is calculated in the appropriate Key-Table from an arbitrary starting position selected in the IV, from a character that corresponds to the result of the first plain text character XOR'd with the encrypted trailing character. This offset points to a specific location within a specific Key-Table as measured from an arbitrary starting point. This offset is then subjected to multiple substitutions within one or more VETs. The output of one of the intermediary VETs may be used to determine the next Key-Table. After these substitutions, the encrypted character is placed in the output stream. VET Banks are incremented and the VET settings are incremented to ensure that repetitious input cannot form a distinguishable pattern in output stream. The next trailing character is selected from the cipher text and subjected to substitutions based on the trailing VETs. This process of obscuring the trailing character is identical on both the encryption and decryption sides. The purpose is to not expose the value of the trailing character which will be XOR'd with the plain character. Then, the cycle begins again, except this time the offset is measured from the location of the last Key-Table, not the initial starting point, and the next selected Key-Table. After a certain number of encryption cycles all of the Crypto-Variables are given new settings.

The three parts of the algorithm (XOR'ing, offsetting, VETs) give it the strength of a three-cord strand. The combination of the XOR'ing and offsetting helps prevent shortcuts in a brute force attack. As soon as the decryption finds an erroneous character in the key, the combination XOR'ing and offsetting insures that the subsequent decryption turns to gibberish. If not for this characteristic, an attacker may discover any remaining key characters that may be correct based on the output. For instance, “AAAÒAzAAÿAAAAA” when the desired result is “AAAÒ [symbol] z²³ [symbol] ÿ Also, attacks on a reduced portion of the key are frustrated as the offsetting process has at its disposal any part of the key for each iteration.

Advantageously, frequency analysis of the present invention is of no value, as the output data stream very closely resembles random data. Known text does not give the attacker any advantage as the combination salt plus IV creates a unique encryption with every message. The relationship between the characters in the cipher text has little or no meaning because a new VET is incorporated for each character.

Further, after a period of 4096, which is 1/16^{th} of the entire cycle for VET iteration, new VETs are selected, new VET setting are selected and VET banks are swapped. Even the moment at which this occurs is unknown as the starting cycle settings are randomly selected.

Further, since AES is implemented in the encrypting of the IV, the task of breaking the algorithm is exponentially more difficult as AES and the present invention need to be broken in concert.

### BRIEF DESCRIPTION OF THE DRAWINGS

For a more complete understanding of the present invention and for further features and advantages, reference is now made to the following description, taken in conjunction with the accompanying drawings, in which:

FIG. 1A illustrates one embodiment of Key-Tables according to the present invention, and FIGS. 1B and 1C illustrate how offsets are derived from Key-Tables;

FIGS. 2A-2C illustrate one embodiment of Variable-Exchange-Tables that may be used according to the present invention;

FIG. 3 illustrates one embodiment of Reverse-Variable-Exchange-Tables that allow the recovery of the values returned from the Variable-Exchange-Tables;

FIGS. 4A-4C illustrate one embodiment of why Variable-Exchange-Tables are different form rotor wheels used in prior art;

FIG. 5 illustrates one embodiment of an Initialization-Vector according to the present invention;

FIG. 6 is a flowchart of one embodiment of a method for encrypting data according to the present invention; and

FIG. 7 illustrates one embodiment of a Key-Table Schedule according to the present invention;

TABLE 1A
Key-Tables

| | |
|---|---|
| 0) | 0.......................................................................238.........255 |
| 1) | 0.............................................................................251...255 |
| 2) | 0..................................................150..............................255 |
| 3) | 0...........34......................................................................255 |
| 4) | 0.........................................139.......................................255 |
| 5) | 0..................................100..............................................255 |
| 6) | 0........................................................................239........255 |
| . | |
| . | |
| . | |
| 10) | 0..................................................165..............................255 |
| 11) | 0.......................................126.........................................255 |
| . | |
| . | |
| . | |
| 15) | 0..................55...............................................................255 |
| 16) | 0......................................................................235..........255 |
| 17) | 0...........................................................216.....................255 |
| . | |
| . | |
| . | |
| 23) | 0...........................................133.....................................255 |
| . | |
| . | |
| . | |
| 61) | 0.......................................................211.........................255 |
| 62) | 0.............................89....................................................255 |
| 63) | 0..................................................................229..............255 |

TABLE 1B
Example 1

| | |
|---|---|
| 0) | 0.......................................................................238.........255 |
| 1) | 0.............................................................................251...255 |

TABLE 1C
Example 2

| | |
|---|---|
| 0) | 0.......................................................................238.........255 |
| . | |
| . | |
| . | |
| 6) | 0........................................................................239........255 |
| . | |
| . | |
| . | |
| 11) | 0.......................................126.........................................255 |
| . | |
| . | |
| . | |
| 16) | 0......................................................................235..........255 |
| . | |
| . | |
| . | |

Variable-Exchange-Tables (VETs)

TABLE 2A
Not shifted

| | | | | | | | | | | | | | | | | | | | |
|---|---|---|---|---|---|---|---|---|---|---|---|---|---|---|---|---|---|---|---|
| 0 | 1 | 2 | 3 | 4 | 5 | 6 | 7 | 8 | 9 | 0 | 1 | 2 | 3 | 4 | 5 | 6 | 7 | 8 | 9 |
| 4 | 8 | 0 | 7 | 1 | 9 | 3 | 5 | 2 | 6 | 4 | 8 | 0 | 7 | 1 | 9 | 3 | 5 | 2 | 6 |

TABLE 2B
Shifted 1 position

| | | | | | | | | | | | | | | | | | | | |
|---|---|---|---|---|---|---|---|---|---|---|---|---|---|---|---|---|---|---|---|
| 9 | 0 | 1 | 2 | 3 | 4 | 5 | 6 | 7 | 8 | 9 | 0 | 1 | 2 | 3 | 4 | 5 | 6 | 7 | 8 |
| 4 | 8 | 0 | 7 | 1 | 9 | 3 | 5 | 2 | 6 | 4 | 8 | 0 | 7 | 1 | 9 | 3 | 5 | 2 | 6 |

TABLE 2C
Shifted 2 positions

| | | | | | | | | | | | | | | | | | | | |
|---|---|---|---|---|---|---|---|---|---|---|---|---|---|---|---|---|---|---|---|
| 8 | 9 | 0 | 1 | 2 | 3 | 4 | 5 | 6 | 7 | 8 | 9 | 0 | 1 | 2 | 3 | 4 | 5 | 6 | 7 |
| 4 | 8 | 0 | 7 | 1 | 9 | 3 | 5 | 2 | 6 | 4 | 8 | 0 | 7 | 1 | 9 | 3 | 5 | 2 | 6 |

TABLE 3
Reverse-Variable-Exchange-Tables (RVETs)

| | | | | | | | | | |
|---|---|---|---|---|---|---|---|---|---|
| 0 | 1 | 2 | 3 | 4 | 5 | 6 | 7 | 8 | 9 |
| 2 | 4 | 8 | 6 | 0 | 7 | 9 | 3 | 1 | 5 |

Variable-Exchange-Tables (VETs)

TABLE 4A
VET1

| | | | | | | | | | | | | | | | | | | | |
|---|---|---|---|---|---|---|---|---|---|---|---|---|---|---|---|---|---|---|---|
| 0 | 1 | 2 | 3 | 4 | 5 | 6 | 7 | 8 | 9 | 0 | 1 | 2 | 3 | 4 | 5 | 6 | 7 | 8 | 9 |
| 4 | 8 | 0 | 7 | 1 | 9 | 3 | 5 | 2 | 6 | 4 | 8 | 0 | 7 | 1 | 9 | 3 | 5 | 2 | 6 |

TABLE 4B
VET2

| | | | | | | | | | | | | | | | | | | | |
|---|---|---|---|---|---|---|---|---|---|---|---|---|---|---|---|---|---|---|---|
| 0 | 1 | 2 | 3 | 4 | 5 | 6 | 7 | 8 | 9 | 0 | 1 | 2 | 3 | 4 | 5 | 6 | 7 | 8 | 9 |
| 8 | 2 | 6 | 5 | 4 | 3 | 0 | 9 | 1 | 7 | 8 | 2 | 6 | 5 | 4 | 3 | 0 | 9 | 1 | 7 |

TABLE 4C
VET3

| | | | | | | | | | | | | | | | | | | | |
|---|---|---|---|---|---|---|---|---|---|---|---|---|---|---|---|---|---|---|---|
| 0 | 1 | 2 | 3 | 4 | 5 | 6 | 7 | 8 | 9 | 0 | 1 | 2 | 3 | 4 | 5 | 6 | 7 | 8 | 9 |
| 1 | 3 | 7 | 4 | 9 | 6 | 0 | 8 | 5 | 2 | 1 | 3 | 7 | 4 | 9 | 6 | 0 | 8 | 5 | 2 |

TABLE 5
Initialization-Vector (IV)

| | | |
|---|---|---|
| VET Setting 1 | possible values 0-255. | (8 bits) |
| VET Setting 2 | possible values 0-255. | (8 bits) |
| VET Setting 3 | possible values 0-255. | (8 bits) |
| VET Setting 4 | possible values 0-255. | (8 bits) |
| VET 1 (Table Selection 1) | possible values 0-15. | (4 bits) |
| VET 2 (Table Selection 2) | possible values 0-15. | (4 bits) |
| VET 3 (Table Selection 3) | possible values 0-15. | (4 bits) |
| VET 4 (Table Selection 4) | possible values 0-15. | (4 bits) |
| Starting Coordinate | possible values 0-255. | (8 bits) |
| Table Number | possible values 0-63. | (6 bits) |
| VET Arrangements | possible values 0-23. | (5 bits) |
| Cycle | possible values 0-4095. | (12 bits) |
| Random Data (salt) | possible values 0-2\hat{ }49 | (49 bits) |

(Salt can be used as a counter to prevent replay attacks)

TABLE 6
Key-Table-Schedule

unsigned char KEY_TABLE_SCHEDULE[512] = {
0,9,1,10,2,11,3,12,4,13,5,14,6,15,7,16,8,
0,10,3,13,6,16,9,2,12,5,15,8,1,11,4,14,7,
0,8,16,7,15,6,14,5,13,4,12,3,11,2,10,1,9,
0,11,5,16,10,4,15,9,3,14,8,2,13,7,1,12,6,
0,7,14,4,11,1,8,15,5,12,2,9,16,6,13,3,10,
0,12,7,2,14,9,4,16,11,6,1,13,8,3,15,10,5,
0,6,12,1,7,13,2,8,14,3,9,15,4,10,16,5,11,
0,13,9,5,1,14,10,6,2,15,11,7,3,16,12,8,4,
0,5,10,15,3,8,13,1,6,11,16,4,9,14,2,7,12,
0,14,11,8,5,2,16,13,10,7,4,1,15,12,9,6,3,
0,4,8,12,16,3,7,11,15,2,6,10,14,1,5,9,13,
0,15,13,11,9,7,5,3,1,16,14,12,10,8,6,4,2,
0,3,6,9,12,15,1,4,7,10,13,16,2,5,8,11,14,
0,16,15,14,13,12,11,10,9,8,7,6,5,4,3,2,1,
0,2,4,6,8,10,12,14,16,1,3,5,7,9,11,13,15,2,
0,9,1,10,2,11,3,12,4,13,5,14,6,15,7,16,8,
0,10,3,13,6,16,9,2,12,5,15,8,1,11,4,14,7,
0,8,16,7,15,6,14,5,13,4,12,3,11,2,10,1,9,
0,11,5,16,10,4,15,9,3,14,8,2,13,7,1,12,6,
0,7,14,4,11,1,8,15,5,12,2,9,16,6,13,3,10,
0,12,7,2,14,9,4,16,11,6,1,13,8,3,15,10,5,
0,6,12,1,7,13,2,8,14,3,9,15,4,10,16,5,11,
0,13,9,5,1,14,10,6,2,15,11,7,3,16,12,8,4,
0,5,10,15,3,8,13,1,6,11,16,4,9,14,2,7,12,
0,14,11,8,5,2,16,13,10,7,4,1,15,12,9,6,3,
0,4,8,12,16,3,7,11,15,2,6,10,14,1,5,9,13,
0,15,13,11,9,7,5,3,1,16,14,12,10,8,6,4,2,
0,3,6,9,12,15,1,4,7,10,13,16,2,5,8,11,14,
0,16,15,14,13,12,11,10,9,8,7,6,5,4,3,2,1,
0,2,4,6,8,10,12,14,16,1,3,5,7,9,11,13,15,2};

### DETAILED DESCRIPTION OF THE PREFERRED EMBODIMENTS AND BEST MODE

For reasons of clarity and brevity the various elements that make up this system and method for data encryption will be illustrated in detail first, then the overall methodology will be discussed in detail.

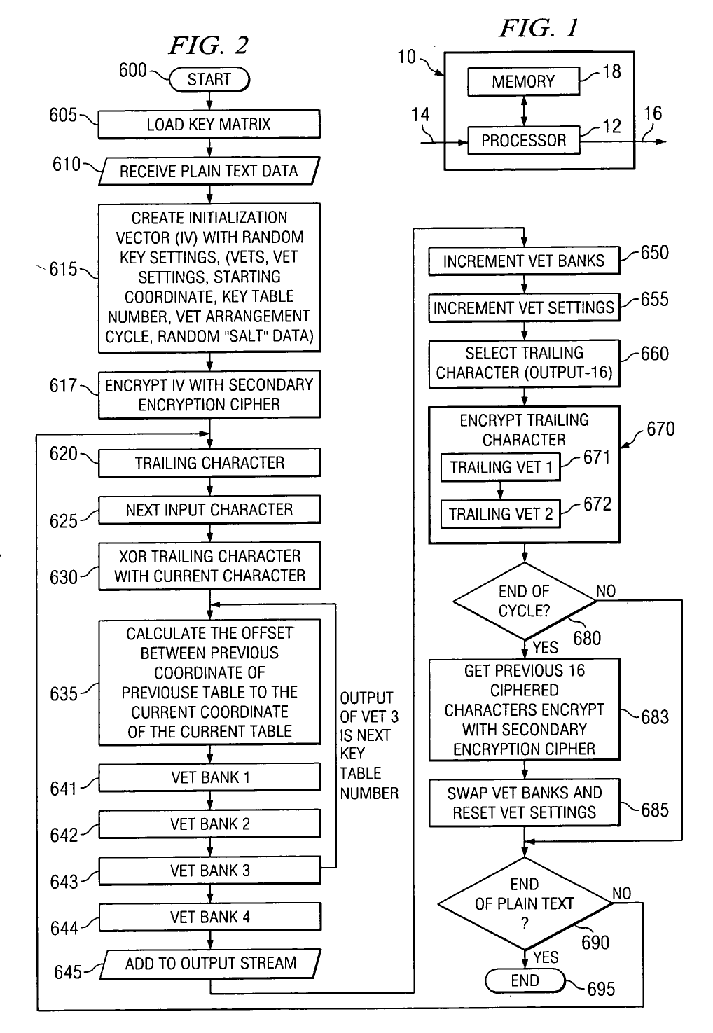

FIG. 1 depicts a system 10 according to the present invention adapted to perform the method of the present invention, seen to include a processor 12 having an input 14 and an output 16, and a memory 18. When system 10 is utilized for encryption, plain text is input to input 14 and encrypted data is provided at output 16. When system 10 is utilized for decryption, encrypted data is provided to input 14 and plan text data is provided at output 16.

Explanation of Offsets

In its simplest terms, an offset is a vector distance from some arbitrary starting point to a point of interest. In the context of this invention, an offset is the distance from some arbitrary point in an indexed array of characters to a character of interest.

FIG. 2A shows 64 separate character arrays also known as Key-Tables, each containing one instance of each of the 256 ASCII characters. In this example the character ‘A’ is located at the position indicated by the middle number. For instance, in the first table, ‘A’ is located at position 238.

Offset Example 1 as Shown in FIG. 2B

The vector distance between ‘A’ in Table 0 and ‘A’ in Table 1 is (251−238)=13. Therefore, the vector or offset is 13.

Offset Example 2 as Shown in FIG. 2C:

For example, if a random starting coordinate is 210 and the plain text is “AAAA” and the table selection is 16,11,6,0 (table selection is derived from another process as will be described shortly) then the following is done by process or 16:

Step 1) Measure the distance between ‘A’ in table 16 and the starting coordinate 210.

(235−210)=25

Step 2) Measure the distance between ‘A’ in table 11 and previous coordinate 235.

(126−235)=−109+256=147 (Note: add 256 if <0)

Step 3) Measure the distance between ‘A’ in table 6 and previous coordinate 126.

(239−126)=113

Step 4) Measure the distance between ‘A’ in table 0 and previous coordinate 239.

(238−239)=−1+256=255 (Note: add 256 if <0)

The resulting offsets are: 25,147,113,255

To recover the offsets:

Start at 210, add 25. Result is 235 in table 16.

Start at 235, add 147. Result is 126 in table 11.

Start at 126, add 113. Result is 239 in table 6.

Start at 239, add 255. Result is 238 at table 0.

Offsetting is advantageous in that it has poly-alphabetic characteristics. For instance, the offset of 25 could be the distance between ‘A’ and ‘A’ or ‘A’ and ‘B’ or potentially any two characters. There are 1,048,576 different ways (64*64*256) to arrive at 25.

Explanation of the Variable-Exchange-Tables

The Variable-Exchange-Tables used by Asier are Roughly analogous to the electromechanical rotors used in crypto machines of the early 20^{th} century.

There are inherent weaknesses in rotor-based encryption when the individual rotors increment by a fixed amount, typically 1, as in the fashion of an odometer. Relationships between the outputted characters will reveal themselves eventually given enough time and data. William F. Friedman's solution to the problem was to increment the rotors in a more erratic fashion.

One important difference is that a mechanical rotor would typically have 26 contacts and thus 26! possible fixed wirings. The VETs of the present invention have 256 characters and are “electronically wired” uniquely for each key.

The present invention eliminates this prior art weakness not only by incrementing the VET settings erratically, but also by rotating new VET for each iteration. The algorithm of the present invention (shown in FIG. 2) has a total of 64 VETs in 4 banks (16 in each bank). The VETs themselves increment in a fashion similar to an odometer, with the middle VETs being the fast VETs. The algorithm of the present invention has a period of 16*16*16*16, or 65536, just for the VETs. (VET stepping is an additional 256*256*256*256) However, before this cycle reaches a period of 4096 (period of 3 VET banks (16*16*16)), the individual VET settings change, individual stepping positions change, and VET arrangements change (VET banks are swapped). The VET setting changes are made in an erratic fashion, accomplishing the same principal as set out by William F. Friedman, but using the method of the present invention having much more entropy—(256!)\hat{ }64^{th} power.

Tables 2A-2C show a Variable-Exchange-Table (VET) with a reduced character set. A value is arrived by passing in an index value and returning the value, stored at that index.

For instance:

In Table 2A, will return 7.

In Table 2B, will return 1.

In Table 2C, will return 9.

Advantageously, the tables are doubled in order the give the tables a circular nature. This will enables an index value to be added, in this case 0-9, to the starting position of 0 in the left half of the table, and arrive at a correct value without having to waste processor time by wrapping back around to the beginning of the table if necessary.

Reverse-Variable-Exchange-Tables

The Reverse-Variable-Exchange-Tables allow the recovery of the values returned from the Variable-Exchange-Tables. For instance:

In the example of Table 2A, 3 returned 7. To recover this value, the index value of 7 is followed and the value of 3 is stored there, thereby recovering the original value.

In the example for Table 2B, 3 returned 1. To recover this value, the index value of 1 is followed and the value of (4−shift value 1)=3 is returned, thereby recovering the original value.

In the example for Table 2C, 3 returned 9. To recover this value, the index value of 9 is followed and the value of (5−shift value 2)=3, thereby recovering the original value.

Why Computer Based VETs of the Present Invention are Different and Advantageous Over Traditional Rotors

One obvious way in which the computer based VETs of the present invention differ from electro-mechanical rotors is that they exist only in a digital world and can be easily replaced. Since VETs are generated and stored on an as needed basis, they are more difficult to steal and copy, especially if they are stored encrypted when not in use.

There are also significant mathematical and operational differences in the use of VETs versus Rotors that will be covered next. Table 4 shows an embodiment of VETs, while Table 2 and Table 3 are referenced for comparative purposes.

In classic rotor based encryption, the encryption of 1 rotor is merely a substitution cipher plus the correct rotor displacement. For example:

Using FIG. 2 as traditional rotors (by ignoring all values to the right of the Grey line)

Table 2A—Not shifted

Table 2B—Shifted 1 position

Table 2C—Shifted 2 positions

These Tables show a rotor with a reduced character set. A value is arrived by passing in an index value and returning the value stored at that index. Afterward, the rotor is shifted 1 position. This is basic rotor encryption and is prior art.

For instance:

In Table 2A 3 will return 7.

In Table 2B 3 will return 1.

In Table 2C 3 will return 9.

Table 3—Reverse Rotor

The reverse rotor allows the recovery of the values substituted in the rotor. For instance:

In the example of Table 2A, for values 7,1,9:

7 returns (3−shift value 0)=3.

1 returns (4−shift value 1)=3.

9 returns (5−shift value 2)=3.

As shown, every substitution is fixed plus the displacement of the rotor setting. It is appreciated things get quite a bit more complicated when using an array of rotors. Still, the possibility of building relationships with the outputted characters exists.

Now, an example of exchanging VETs will be discussed (all tables are set to 0 in this example):

Note that the tables are doubled in order the give the tables a circular nature. This enables an index value to be added, in this case 0-9, to the starting position of 0 in the left half of the table, and arrive at a correct value without having to wrap back around to the beginning of the table.

Table 4A—VET1

Table 4B—VET2

Table 4C—VET3

In Table 4A 3 will return 7.

In Table 4B 3 will return 5.

In Table 4C 3 will return 4.

In terms of classic rotor based encryption, this method has the net effect of shifting the first VET (Table 4A) 0,4,7, thus accomplishing an erratic table (rotor) movement. This erratic effect is achieved using very little computer processing. One might think using a pseudo random number generator to shift the VET might be a better fit, however, it takes almost as many processor steps to generate a random number as it does to encrypt a character. This is one major difference between the methodology of the present invention and prior art.

Also, after a period of 4096, all the VET settings are randomly reset. Note the 4096 is 16*16*16, or a period of 3 VET banks. This is done so that at the moment there may be information leaked, all the crypto variables are changed. In other words, an attacker is has at most 4096 characters with which cryptanalysis could take place, which is not near enough data to work with.

To summarize:

VETs are 256 characters long and not the normal 26.

This invention incorporates a new rotor between each encrypted character.

VETs are “wired” uniquely.

VETs are doubled in memory to accommodate the computer environment, without using extra processing power to wrap the table back around.

After a period, all the VET settings and VET banks change.

Explanation of the Initialization-Vector

Table 5 shows the Initialization-Vector (“IV”), which sets the initial state of the algorithm and assigns values to all the Crypto-Variables.

The values of the IV are obtained by using a PRNG. To obscure the values of the IV from an attacker, the IV is encrypted by using the AES block cipher. The reason for using AES is to take advantage of the confusion/diffusion properties of block ciphers. If there is just 1 bit difference in the IV, the resulting AES cipher text will be completely different. Therefore, it takes all 16 characters of the IV to arrive at the correct settings. To accommodate the AES algorithm, the IV has a total of 16 characters. As such, the encrypted data will expand by 16 bytes.

The IV serves 2 purposes—obscuring the VET settings, and providing salt for the encrypted message. This dual purpose advantageously prevents the same message encrypting the same way twice. For the same message to be encrypted the same way twice with the same key, all of the Crypto-Variable settings need to be identical. Additionally, the same Random Data (salt) needs to be selected as well. One bit difference will result in a completely different AES encryption, which in turn will create a completely different cipher text (the combination of the trailing XOR and offsetting insures this). As a result, the only way to recover the IV is an exhaustive search of 128 bits.

Explanation of the Encryption Process

FIG. 2 shows a flow chart of the encryption process according to the present invention. The process begins at step 600. At step 605, the encryption key is loaded into memory 18. Some portions of the key appear more the once in the memory 18, and this is to facilitate the fastest possible encryption.

At step 610 a plain text data buffer is received.

At step 615, the Initialization-Vector (IV) is created. This IV contains the Crypto-Variables necessary to carry out the encryption process. Value selection for these variables is accomplished with either a true random number generator (TRNG) or a pseudo random number generator (PRNG). The first four of these variables are the starting position settings of the four VETs, and these may have any value 0-255. Which individual VETs to use out of the banks are selected next. In this embodiment, there are 16 VETs in each of the four banks. A Key-Table from each bank is selected with possible values are 0-15. Next, a starting coordinate within the first Key-Table is randomly selected and may have any value 0-255. Which of the sixty-four Key-Tables to start with is selected next. There are twenty-four different ways to arrange 4 banks of VETs, and one of these is selected. Next, the number of plain text characters to encrypt before selecting new Crypto-Variables is randomly chosen. The allowable values for this 0-4095, which is many orders of magnitude smaller then the calculated characteristic repetition period of this cipher. Finally, several bits of random data are generated and placed in the IV. This is used as filler, however, can work quit nicely as a message counter.

In step 617, a block cipher such as AES, is used to encrypt the entire IV before it is added to an output buffer.

At step 620, a trailing cipher character is selected, which may be any distance of 1-16 characters before the current character, but in this embodiment, is 16 characters before the current cipher character. Since the encryption process has just started, the first character in the encrypted IV of the output buffer is selected and subjected to step 670 before it is applied to step 630.

In step 625, the first character in the input buffer becomes the current character. In step 630, the encrypted trailing cipher character is XOR'd with the current character. This is a bit-wise integer operation that effectively obscures the current character. Step 635 calculates an offset between the previous coordinate in the previous Key-Table and the current coordinate in the current Key-Table. In the case of the first character, the offset is measured from the starting coordinate selected in Step 615, and the current (XOR'd) character in the Key-Table also is selected in step 615.

In step 641, the offset generated in step 635 is used as an index to a first VET which outputs a completely different value. In step 642, the output generated in step 641 is used as an index to a the second VET which outputs a completely different value. In step 643, the output generated in step 642 is used as an index to a second VET which outputs a completely different value. This value is passed to step 644, but is also used to determine the next Key-Table.

In step 644, the output generated in step 643, is used as an index to the second VET which outputs a completely different value. In step 645, the result of step 644 is placed into the output buffer. Step 650 rotates the appropriate tables of VET banks. Step 655 increments the starting position of the appropriate VETs.

Step 660 selects the next trailing cipher character that has already been encrypted. Step 670 further obscures the meaning of the trailing character by encrypting it again. This is so the trailing cipher character in never exposed. Substitutions are carried out on the trailing cipher character by applying trailing VETs to it. In steps 671 and 672, the output from step 672 is fed into step 620. Step 680 checks to see if the cycle length established in step 615 has expired. If it hasn't expired, and if it is not the end of the plain text (step 690), then operations proceed to step 620. If step 680 finds that the cycle has ended, then it proceeds to step 683. In step 683, the last 16 ciphered characters are copied from the output buffer and subjected to a secondary block cipher. In step 685, the output of the block ciphered cipher text is parsed and used to reset the Crypto-Variable before encryption operations can resume. Step 690 checks to see it there are any more plain text characters to encrypt. If necessary, the process proceeds to step 620, if not, it ends at step 695.

Explanation of the Key-Table-Schedule

Table 7 shows the Key-Table-Schedule for a key block of 17 Key-Tables. This table or array selects the next table for offsetting operations. For instance if the first table selected was at the beginning of this array, then Key-Table 0 is selected, then Key-Table 9, then Key-Table 10, etc. This array is doubled so that the algorithm can start at any index (top half) 0-255, and continue for 256 iterations without going beyond the range of the array. An alternative embodiment uses the output of one of the Variable-Exchange-Tables to select the next Key-Table and does not use a Key-Table-Schedule.

The Relationship Between Key-Tables and Variable-Exchange-Tables

Key-Table and VETs were each described in there own section. A Key Table is an indexed array filed with randomly chosen values corresponding to the character set. The Key-Tables are used to determine a vector between the location of a plain character in one Key-Table and the next. A VET is a “Special Use” of a Key-Table. What is meant by this is that exactly the same array is used, but instead of measuring the distance between indices to find an offset vector, a value is brought to the VET, that value indicated which indexed character in Table should be substituted for the original value.

Sample Encryption

KEY TABLE 0

| | | | | | | | | | |
|---|---|---|---|---|---|---|---|---|---|
| A | B | C | D | E | F | G | H | I | J |
| H | E | J | A | F | G | C | I | D | B |

KEY TABLE 1

| | | | | | | | | | |
|---|---|---|---|---|---|---|---|---|---|
| A | B | C | D | E | F | G | H | I | J |
| C | J | G | I | H | D | B | A | E | F |

KEY TABLE 2

| | | | | | | | | | |
|---|---|---|---|---|---|---|---|---|---|
| A | B | C | D | E | F | G | H | I | J |
| B | F | E | H | A | C | F | D | G | I |

KEY TABLE 3

| | | | | | | | | | |
|---|---|---|---|---|---|---|---|---|---|
| A | B | C | D | E | F | G | H | I | J |
| C | I | F | G | B | A | D | J | H | E |

KEY TABLE 4

| | | | | | | | | | |
|---|---|---|---|---|---|---|---|---|---|
| A | B | C | D | E | F | G | H | I | J |
| D | J | E | H | G | A | C | I | B | F |

KEY TABLE 5

| | | | | | | | | | |
|---|---|---|---|---|---|---|---|---|---|
| A | B | C | D | E | F | G | H | I | J |
| I | J | E | D | A | G | B | H | F | C |

KEY TABLE 6

| | | | | | | | | | |
|---|---|---|---|---|---|---|---|---|---|
| A | B | C | D | E | F | G | H | I | J |
| F | A | D | C | J | G | B | H | E | I |

KEY TABLE 7

| | | | | | | | | | |
|---|---|---|---|---|---|---|---|---|---|
| A | B | C | D | E | F | G | H | I | J |
| B | F | G | H | I | C | D | J | A | E |

KEY TABLE 8

| | | | | | | | | | |
|---|---|---|---|---|---|---|---|---|---|
| A | B | C | D | E | F | G | H | I | J |
| F | A | C | B | E | I | J | G | D | H |

KEY TABLE 9

| | | | | | | | | | |
|---|---|---|---|---|---|---|---|---|---|
| A | B | C | D | E | F | G | H | I | J |
| A | H | D | G | F | J | I | C | B | E |

Above are 10 Key-Tables with a reduced character set.

A=0, B=1, C=2, D=3, E=4, F=5, G=6, H=7, 1=8, J=9

KEY TABLE 0
VET Bank 1

| | |
|---|---|
| A | H |
| B | E |
| C | J |
| D | A |
| E | F |
| F | G |
| G | C |
| H | I |
| I | D |
| J | B |

KEY TABLE 3
VET Bank 2

| | |
|---|---|
| A | C |
| B | I |
| C | F |
| D | G |
| E | B |
| F | A |
| G | D |
| H | J |
| I | H |
| J | E |

KEY TABLE 6
VET Bank 3

| | |
|---|---|
| A | F |
| B | A |
| C | D |
| D | C |
| E | J |
| F | G |
| G | B |
| H | H |
| I | E |
| J | I |

KEY TABLE 1

| | |
|---|---|
| A | C |
| B | J |
| C | G |
| D | I |
| E | H |
| F | D |
| G | B |
| H | A |
| I | E |
| J | F |

KEY TABLE 4

| | |
|---|---|
| A | D |
| B | J |
| C | E |
| D | H |
| E | G |
| F | A |
| G | C |
| H | I |
| I | B |
| J | F |

KEY TABLE 7

| | |
|---|---|
| A | B |
| B | F |
| C | G |
| D | H |
| E | I |
| F | C |
| G | D |
| H | J |
| I | A |
| J | E |

KEY TABLE 2

| | |
|---|---|
| A | B |
| B | F |
| C | E |
| D | H |
| E | A |
| F | C |
| G | F |
| H | D |
| I | G |
| J | I |

KEY TABLE 5

| | |
|---|---|
| A | I |
| B | J |
| C | E |
| D | D |
| E | A |
| F | G |
| G | B |
| H | H |
| I | F |
| J | C |

KEY TABLE 8

| | |
|---|---|
| A | F |
| B | A |
| C | C |
| D | B |
| E | E |
| F | I |
| G | J |
| H | G |
| I | D |
| J | H |

Above are three Variable-Exchange-Table (VET) Banks.

An example of encrypting the phrase “CIA”:

As shown in the flow chart of FIG. 2, the first step creates an initialization-vector (IV). For the sake of brevity, the crypto-variables are set to 0, except for the VET table selection in VET Bank 2 (set to 1) and the IV is arbitrarily encrypted with characters found in the tables. The encryption of the IV is done with a block cipher and in this example is not necessary to demonstrate as it is already well known to anyone practiced in the art.

IV=G, D, B, . . .

Crypto-Variables:

VET Setting1=0

VET Setting2=0

VET Setting3=0

VET 1(tbl selection)=0

VET 2(tbl selection)=1

VET 3(tbl selection)=0

Coordinate(starting)=2

TableNum=4

Take first character in the IV and push through the trailing VET's, which in this case is made up of Key-Table 9 and 3.

KEY TABLE 9

| | |
|---|---|
| A | A |
| B | H |
| C | D |
| D | G |
| E | F |
| F | J |
| G | I |
| H | C |
| I | B |
| J | E |

KEY TABLE 3

| | |
|---|---|
| A | C |
| B | I |
| C | F |
| D | G |
| E | B |
| F | A |
| G | D |
| H | J |
| I | H |
| J | E |

G becomes I then I becomes H, or numerically speaking 7

Take 7 and xor with ‘C’.

H(7)\hat{ }C(2)=F(5)

Locate the position of ‘F’ in Key-Table 4, 4 was assigned to the TableNum variable in the creation of the IV.

F is found in the 9^{th} position in Key-Table 4.

Take 9 and subtract starting Coordinate of 2.

9−2=7, 7 now becomes the current Coordinate.

Take H(7) and push it thru 1 table in each of the VET banks.

Note: to comply with the IV settings, VET Bank 2 is rotated to hold the second table or VET in the Bank.

KEY TABLE 0

| | |
|---|---|
| A | H |
| B | E |
| C | J |
| D | A |
| E | F |
| F | G |
| G | C |
| H | I |
| I | D |
| J | B |

KEY TABLE 4

| | |
|---|---|
| A | D |
| B | J |
| C | E |
| D | H |
| E | G |
| F | A |
| G | C |
| H | I |
| I | B |
| J | F |

KEY TABLE 6

| | |
|---|---|
| A | F |
| B | A |
| C | D |
| D | C |
| E | J |
| F | G |
| G | B |
| H | H |
| I | E |
| J | I |

H becomes I, I becomes B, B becomes A

Note: the TableNum variable is assigned B or 1 for the next round.

A is the first cipher character.

Repeat the process for the character ‘I’

Take the next cipher character in the IV ‘D’ and push thru the trailing VET's. Note, the starting position in the first trailing VET is incremented by 1.

KEY TABLE 9

| | |
|---|---|
| A | H |
| B | D |
| C | G |
| D | F |
| E | J |
| F | I |
| G | C |
| H | B |
| I | E |
| J | A |

KEY TABLE 3

| | |
|---|---|
| A | C |
| B | I |
| C | F |
| D | G |
| E | B |
| F | A |
| G | D |
| H | J |
| I | H |
| J | E |

D becomes F, F becomes A

Xor A with the next character ‘I’ of “CIA”

A(0)\hat{ }I(8)=I(8)

Locate the position of ‘I’ in Key-Table 1, which is the current value of the TableNum variable.

I is found in the 3rd position in Key-Table 1.

Take 3 and subtract current Coordinate of 7.

3−7=−4+10=6, 6 now becomes the current Coordinate.

Take 6 or G and push it thru 1 table in each of the VET Banks.

Note: a new table in VET Bank 2 is rotated to hold the third table in the Bank. Also note that the starting position of the middle table is incremented by 1.

KEY TABLE 0

| | |
|---|---|
| A | H |
| B | E |
| C | J |
| D | A |
| E | F |
| F | G |
| G | C |
| H | I |
| I | D |
| J | B |

KEY TABLE 5

| | |
|---|---|
| A | J |
| B | E |
| C | D |
| D | A |
| E | G |
| F | B |
| G | H |
| H | F |
| I | C |
| J | I |

KEY TABLE 6

| | |
|---|---|
| A | F |
| B | A |
| C | D |
| D | C |
| E | J |
| F | G |
| G | B |
| H | H |
| I | E |
| J | I |

G becomes C, C becomes D, D becomes C

Note: the TableNum variable is assigned D or 3 for the next round.

C is the next cipher character.

Repeat the process for the character ‘A’

Take the next cipher character in the IV ‘B’ and push thru the trailing VET's. Note the starting position in the first trailing VET is again incremented by 1.

KEY TABLE 9

| | |
|---|---|
| A | D |
| B | G |
| C | F |
| D | J |
| E | I |
| F | C |
| G | B |
| H | E |
| I | A |
| J | H |

KEY TABLE 3

| | |
|---|---|
| A | C |
| B | I |
| C | F |
| D | G |
| E | B |
| F | A |
| G | D |
| H | J |
| I | H |
| J | E |

B becomes G, G becomes D

Xor D with the next character ‘A’ of “CIA”

G(6)\hat{ }A(0)=G(6)

Locate the position of ‘G’ in Key-Table 3, Which is the current value of the tableNum variable.

G is found in the 3rd position in Key-Table 3.

Take 3 and subtract current Coordinate of 6.

3−6=−3+10=7, 7 now becomes the current Coordinate.

Take 7 or H and push it thru 1 table in each of the VET Banks.

Note: a new table in VET Bank 2 is wrapped back around to hold the first table in the Bank. Also note that the starting position of the middle table is incremented by 1. Also note that the second table in VET Bank 3 is rotated into position.

KEY TABLE 0

| | |
|---|---|
| A | H |
| B | E |
| C | J |
| D | A |
| E | F |
| F | G |
| G | C |
| H | I |
| I | D |
| J | B |

KEY TABLE 3

| | |
|---|---|
| A | F |
| B | G |
| C | B |
| D | A |
| E | D |
| F | J |
| G | H |
| H | E |
| I | C |
| J | I |

KEY TABLE 7

| | |
|---|---|
| A | B |
| B | F |
| C | G |
| D | H |
| E | I |
| F | C |
| G | D |
| H | J |
| I | A |
| J | E |

H becomes I, I becomes C, C becomes G

G is the last cipher character.

The resulting IV plus cipher text looks like this:

GDB . . . ACG

One embodiment of this invention has a symmetric encryption key length of 40,960 bits, and can encrypt data substantially faster than AES can with a 256 bit key. This has been fully realized as computer software and tested.

Embodiments of the invention provide numerous technical advantages. One technical advantage of one embodiment is that relative offsets between key characters that correspond to plain characters are used to encrypt a message. By using relative offsets and trailing XORs, the encryption of a message results in a different output each time the message is encrypted, thus improving security without substantial use of processing power or time. Another technical advantage of one embodiment is that changing anything in the IV results in different encrypted characters, even when the same message is encrypted multiple times.

Another technical advantage of one embodiment is that a key may have many Key-Tables driving the overall size of the key into the tens or hundreds of thousands of bits, effectively preventing an exhaustive key search or an equation solving attack. Since all of the operations are integer based, modern computers can do them very rapidly. An encryption system based on this embodiment with a typical 40,960 bit key can encrypt data faster than AES can with a 256 bit key and has substantially more possible keys.

Additional modifications of the invention for specific operational requirements are within the scope of this invention, such as having more or fewer VETs and/or VET banks, longer periods for the cycle, and incrementing VET settings between each byte by a non fixed amount. Any block cipher can be substituted for AES as long as the confusion/diffusion properties remain.

Although an embodiment of the invention and its advantages are described in detail, a person skilled in the art could make various alterations, additions, and omissions without departing from the spirit and scope of the present invention as defined by the appended claims.

Other technical advantages are readily apparent to one skilled in the art from the following FIGURES, descriptions, and claims.

What is claimed is:

1. A system for data encryption, the system comprising:
an input operable to receive a plurality of plain characters;
a memory operable to store a Key-Table comprising a plurality of key characters, each of the plain characters corresponding to one of the key characters of the plurality of plain characters;
a processor coupled to the memory and to the input, operable to repeat the following for each said plain character to encrypt the plain characters:
locate a current key character corresponding to a current plain character; and
locate a next key character corresponding to a next plain character;
an offset module coupled to the processor and operable to repeat the following for each said plain character to encrypt the plain characters:
determine an offset between a current said key character and a next said key character; and
an output coupled to the offset module and operable to provide encrypted characters as a function of the offsets.

2. The system of claim 1, wherein the key characters are associated with a coordinate system, and the offset is represented as a vector offset.

3. The system of claim 1, wherein each of the plain characters is associated with one variable denoting the position of said plan character within the Key-Table.

4. The system of claim 1, wherein the Key-Table contains the key characters such that there is one instance of each possible plain text character represented in the Key-Table.

5. The system of claim 1, further comprising a key block containing a plurality of the Key-Tables.

6. The system of claim 5, wherein the different Key-Tables are accessable with successive said plain characters.

7. The system of claim 6, wherein the processor determines an offset between key characters in current and successive said Key-Tables.

8. The system of claim 7, wherein the Key-Tables are selected by the processor in a set order.

9. The system of claim 7, wherein the Key-Tables are selected by the processor in an erratic order.

10. The system of claim 7, further comprising a table schedule defining a pattern selection of the Key-Tables.

11. A system of claim 1, further comprising of one or more Variable-Exchange-Tables where, plain character to key character substitution takes place to produce a result.

12. The system of claim 11, wherein the Variable-Exchange-Tables have one said key character for each possible said plain text character.

13. The system of claim 12, wherein the Variable-Exchange-Tables are doubled to give the Variable-Exchange-Tables a circular nature.

14. The system of claim 12, wherein the Key Tables can be used as Variable-Exchange-Tables.

15. The system of claim 1, wherein the offset is associated with a key character in a Variable-Exchange-Table determined by an index.

16. The system of claim 15, wherein the index is the sum of the offset plus a starting position of a current said Variable-Exchange-Table.

17. The system of claim 11, further comprising a plurality of said Variable-Exchange-Tables, wherein one of the Variable-Exchange-Table passes a substituted character into a succession of Variable-Exchange-Tables.

18. The system of claim 17, wherein the result of a previous said Variable-Exchange-Table is associated with a character in a next said Variable-Exchange-Table determined by the index.

19. The system of claim 18, wherein the index is the sum of the result of the previous Variable-Exchange-Table plus a starting position of the current Variable-Exchange-Table.

20. The system of claim 11, further comprising a plurality of Variable-Exchange-Tables, wherein a starting position of the Variable-Exchange-Tables is incrementable to produce different outputs for a same said input.

21. The system of claim 11, further comprising a plurality of Variable-Exchange-Tables, wherein the plurality of Variable-Exchange-Tables are grouped into banks where there are an equal amount of said Variable-Exchange-Tables in each said bank.

22. The system of claim 21, wherein the Variable-Exchange-Tables are rotatable and substitutable with another said Variable-Exchange-Table located within the same said bank periodically.

23. The system of claim 21, wherein the Variable-Exchange-Table banks are periodically rearranged.

24. The system of claim 11, wherein the result of one of the Variable-Exchange-Tables determines a next said Key-Table to be selected for the determining of offsets.

25. The system of claim 1, wherein a trailing cipher character some distance in the past is XOR'd with the offset.

26. The system of claim 1, wherein a trailing cipher character some distance in the past is XOR'd with the plain character before an offset is calculated.

27. The system of claim 25, wherein the trailing cipher character is passed through a set of Variable-Exchange-Tables before it is XOR'd with a current said offset.

28. The system of claim 26, wherein the trailing cipher character is passed through a set of Variable-Exchange-Tables before it is XOR'd with a current said plain character.

29. The system of claim 1, wherein Crypto-Variables necessary to perform cryptographic operations are determined and assigned by the processor to an initialization vector, including a selection, arrangement, and scheduling of variable components within an encryption algorithm including Variable-Exchange-Tables.

30. The system of claim 29, wherein an initial starting coordinate for determining the offset is randomly selected by the processor and stored within an initialization vector.

31. The system of claim 29, wherein an initial selection of the Variable-Exchange-Tables are randomly selected by the processor and stored within the initialization vector.

32. The system of claim 29, wherein the Variable-Exchange-Table groupings are randomly selected by the processor and stored within the initialization vector.

33. The system of claim 29, wherein a period is randomly determined by the processor to create a new set of said Crypto-Variables.

34. The system of claim 33, wherein a length of the period is fixed.

35. The system of claim 29, wherein an initial starting position for the Variable-Exchange-Tables are randomly selected by the processor and stored within the initialization vector.

36. The system of claim 29, wherein a variable defining the initial Key-Table selection is randomly selected by the processor and stored within the initialization vector.

37. The system of claim 29, wherein the initialization vector also contains a message counter.

38. The system of claim 29, wherein the initialization vector also contains information for defining a hierarchical key.

39. The system of claim 29, further comprising a secondary block cipher concealing the Crypto-Variable in the initialization vector.

40. The system of claim 39, wherein the secondary block cipher is AES.

41. The system of claim 29, wherein at the end of a period a new set of said Crypto-Variables are created by the processor.

42. The system of claim 41, wherein the selection of the new Crypto-Variables are a function of encrypting a block of cipher text taken from the output with a secondary block cipher.

43. The system of claim 42, wherein the secondary block cipher is AES.

44. The system of claim 4, wherein each said Key-Table is randomly populated.

45. The system of claim 44, wherein the processor populates elements in a structured array in a sequential manner.

46. The system of claim 45, wherein the elements in the structured array are randomly selected and assigned to the Key-Table at a next available slot.

47. The system of claim 46, wherein a true random number generator is used by the processor.

48. The system of claim 46, wherein a pseudo random number generator is used by the processor.

49. The system of claim 46, wherein a selected said element in the structured array is replaced by a last said element in the structured array.

50. The system of claim 49, wherein the structured array has a length reduced by 1 for each said element selected.

51. The system of claim 45, wherein an erratic timing function is introduced by the processor between each said element selected.

52. The system of claim 51, wherein a value returned from a pseudo random number generator and a value returned from the erratic timing function are XOR'd together to further reduce a predictability of the element selected.

53. The system of claim 51, wherein the erratic timing function is adapted to make calls to a hard drive, wherein the processor comprises a high performance counter creating the erratic timing function.

54. A method of data encryption, the method comprising:
receiving a plurality of plain characters;
accessing a Key-Table comprising a plurality of key characters, each said plain character corresponding to one said key character of the plurality of key characters; and
repeating the following for subsequent said plain characters to encrypt the plain characters:
locating a current said key character corresponding to a current said plain character;
locating a next key character corresponding to a next said plain character; and
determining an offset between the current key character and the next key character.

55. The method of claim 54, wherein the key characters are associated with a coordinate system, and the offset is represented as a vector offset.

56. The method of claim 54, wherein each of the plain characters are associated with variable(s) denoting a position of the plain character within the Key-Table.

57. The method of claim 54, wherein the Key-Table contains the key characters such that there is one instance of the key character for each possible said plain character.

58. The method of claim 54, wherein the Key-Table is one of several said Key-Tables forming a key block.

59. The method of claim 58, further comprising the step of accessing different said Key-Tables for successive said plain characters.

60. The method of claim 59, wherein the offset is measured between the key characters in successive said Key-Tables.

61. The method of claim 60, further comprising the step of accessing the Key-Tables in a selected set order.

62. The method of claim 60, further comprising the step of accessing the Key-Tables in an erratic order.

63. The method of claim 60, further comprising the step of utilizing a table schedule defining a pattern for the Key-Table selection.

64. A method of claim 54, further comprising the step of utilizing at least one Variable-Exchange-Table and performing character substitution of said corresponding key characters for each said plain character.

65. The method of claim 64, wherein a plurality of the Variable-Exchange-Tables have VET characters comprising one instance of each possible said plain character.

66. The method of claim 65, wherein the Variable-Exchange-Tables are doubled such that the Variable-Exchange-Tables have a circular nature.

67. The method of claim 65, wherein the Variable-Exchange-Tables are formed as a function of the Key-Tables.

68. The method of claim 54, wherein the offset is associated with a VET character in a Variable-Exchange-Table determined by an index.

69. The method of claim 68, wherein the index is the sum of the offset plus a starting position of a current Variable-Exchange-Table.

70. The method of claim 68, further comprising the step of passing the result of one said Variable-Exchange-Table into a succession of the Variable-Exchange-Tables.

71. The method of claim 70, wherein the result of a previous said Variable-Exchange-Table is associated with a VET character in a next said Variable-Exchange-Table determined by the index.

72. The method of claim 71, wherein the index is a sum of the result of the previous Variable-Exchange-Table plus the starting position of the current Variable-Exchange-Table.

73. The method of claim 64, wherein the Variable-Exchange-Tables starting position can be incremented to produce different said VET characters for the same plain character.

74. The method of claim 64, wherein the plurality of Variable-Exchange-Tables are grouped into banks where there are an equal amount of the Variable-Exchange-Tables in each said bank.

75. The method of claim 74, wherein the Variable-Exchange-Tables substituted with another said Variable-Exchange-Table are located within the same bank periodically.

76. The method of claim 74, further comprising the step of rearranging the Variable-Exchange-Table banks periodically.

77. The method of claim 60, wherein the VET characters of one of the Variable-Exchange-Tables are used to determine a next said Key-Table for the calculation of the offsets.

78. The method of claim 54, further comprising the step of XOR'ing a trailing cipher character some distance in the past with the offset.

79. The method of claim 54, further comprising the step of XOR'ing a trailing cipher character some distance in the past with the plain character before the offset is calculated.

80. The method of claim 78, wherein the trailing cipher character is passed through a special set Variable-Exchange-Tables before it is XOR'd with a current said offset.

81. The method of claim 79, wherein the trailing cipher character is passed through a special set Variable-Exchange-Tables before it is XOR'd with the current plain character.

82. The method of claim 54, wherein Crypto-Variables necessary to perform cryptographic operations are determined and assigned to an initialization vector, a selection, arrangement, and scheduling of variable components within the Variable-Exchange-Tables.

83. The method of claim 82, wherein an initial starting coordinate for offsetting is randomly selected and stored within an initialization vector.

84. The method of claim 82, wherein an initial selection of the Variable-Exchange-Tables is randomly selected and stored within an initialization vector.

85. The method of claim 82, wherein the Variable-Exchange-Table are grouped by random selection and stored within an initialization vector.

86. The method of claim 82, wherein a period is randomly determined that creates a new set of Crypto-Variables.

87. The method of claim 86, wherein the period length is fixed.

88. The method of claim 83, wherein the initial starting coordinate of the Variable-Exchange-Tables is randomly selected and stored within the initialization vector.

89. The method of claim 83, wherein a variable defining an initial Key-Table selection is randomly selected and stored within the initialization vector.

90. The method of claim 83, wherein the initialization vector also contains a message counter.

91. The method of claim 83, wherein the initialization vector also contains information defining a hierarchical key.

92. The method of claim 83, wherein a secondary block cipher is used to conceal information in the initialization vector.

93. The method of claim 92, wherein the secondary block cipher is AES.

94. The method of claim 82, wherein at the end of a period a new set of the Crypto-Variables are selected.

95. The method of claim 94, wherein the selection of the new Crypto-Variables are a function of encrypting a block of cipher text taken from a secondary block cipher.

96. The method of claim 95, wherein the secondary block cipher is AES.

97. The method of claim 57, wherein each said Key-Table is randomly populated with the key characters.

98. The method of claim 97, further comprising the step of populating a structured array with elements in a sequential manner.

99. The method of claim 98, wherein the elements in the structured array are randomly selected and assigned to one said Key-Table at a next available slot.

100. The method of claim 99, wherein a true random number generator is used to randomly select the elements.

101. The method of claim 99, wherein a pseudo random number generator is used to randomly select the elements.

102. The method of claim 99, further comprising the step of replacing one of the selected elements in the structured array is replaced by the last element in the structured array

103. The method of claim 102, further comprising the step of reducing the structured array length is reduced by 1 for each said element selected.

104. The method of claim 101, further comprising the step of reducing an erratic timing function between each said element selection.

105. The method of claim 104, wherein a value returned from the pseudo random number generator and a value returned from the erratic timing function are XOR'd together to further reduce the predictability of the element selection.

106. The method of claim 104, wherein a timing of function calls are made to a hard drive and are measured with a high performance counter to create the erratic timing function.

107. The method of claim 64, wherein the key tables and the variable Exchange tables realize an encryption key containing many thousands of bits.

108. A system for data decryption, the system comprising:
a input operable to receive encrypted data associated with a plurality of plain characters, the encrypted data comprising a plurality of encrypted offsets;
a memory operable to store a Key-Table comprising a plurality of key characters, each said plain character corresponding to a said key character;
a processor operable to repeat the following for a subsequent said encrypted offset to decrypt the encrypted data:
locate a current said key character;
locate a next said key character corresponding the encrypted offset applied to the current key character; and
determine the plain character corresponding to the next said key character.

109. The system of claim 108 wherein the processor receives an initialization vector associated with encrypted with a block cipher, decrypts the initialization vector, and loads key components to the memory based on the initialization vector.

110. The system of claim 109, wherein the processor decrypts the initialization vector by is parsing, and further assigns values to Crypto-Variables to decrypt encrypted text.

111. The system of claim 110, further comprising Reverse-Variable-Exchange-Tables that are the inverse of Variable-Exchange-Tables used to encrypt the encrypted data, and which enable substitutions made by the Variable-Exchange-Tables to be recovered by the Reverse-Variable-Exchange Tables.

112. The system of claim 108, further comprising The Reverse-Variable-Exchange-Tables decrypting the encrypted offsets.

113. The system of claim 112 wherein the processor applies a correct said Reverse-Variable-Exchange-Table to one said encrypted character in a correct order so as to reveal anon-encrypted offset.

114. The system of claim 113, further comprising an initialization vector determining the selection and scheduling of the Reverse-Variable-Exchange-Table.

115. The system of claim 108 wherein the processor performs the step of taking the revealed non-encrypted offset, adding the revealed offset to a current coordinate, and looking up the corresponding plain text character.

116. The system of claim 108 wherein the processor XOR's a trailing character with the located key character to reveal the plain text character.

117. A method for data decryption, the method comprising the steps of:
receiving encrypted data associated with a plurality of plain characters, the encrypted data comprising a plurality of encrypted offsets;
accessing a Key-Table comprising a plurality of key characters, each plain character corresponding to one said key character;
repeating the following for a subsequent said encrypted offset to decrypt the encrypted data:
locate a current key character;
locate a next said key character corresponding the encrypted offset applied to the current said key character; and
determine the plain character corresponding to the next said key character.

118. The method of claim 117 further comprising the step of receiving an initialization vector encrypted with a block cipher, decrypting the initialization vector, and loading key components to memory based on the initialization vector.

119. The method of claim 118, wherein the decrypted initialization vector is parsed, further comprising the step of assigning values to Crypto-Variables included in the initialization vector to decrypt encrypted text.

120. The method of claim 117, further comprising the step of using Reverse-Variable-Exchange-Tables that are the inverse of Variable-Exchange-Tables used to encrypt the encrypted data, enabling substitutions made by the Variable-Exchange-Tables to be recovered by the Reverse-Variable-Tables.

121. The method of claim 120, wherein The Reverse-Variable-Exchange-Tables are used to decrypt the encrypted offsets.

122. The method of claim 121 further comprising the step of applying a correct said Reverse-Variable-Exchange-Table to one said encrypted character in a correct order so as to reveal an encrypted offset.

123. The method of claim 122, wherein Reverse-Variable-Exchange-Table selection and scheduling are determined in an initialization vector.

124. The method of claim 122 further comprising the step of taking the revealed non-encrypted offset, and adding the revealed offset to a current coordinate, and looking up the corresponding plain text character as a function of this addition.

125. The method of claim 117 further comprising the step of XOR'ing a trailing character with the located key character to reveal the plain text character.
